(19) United States
(12) Patent Application Publication
(10) Pub. No.: US 2007/0189941 A1
(43) Pub. Date: Aug. 16, 2007

(54) Kit For Recovery Of Metal

(75) Inventor: Robert E. UNION, Westford, MA (US)

Correspondence Address: GROSSMAN, TUCKER, PERREAULT & PFLEGER, PLLC, 55 SOUTH COMMERICAL STREET, MANCHESTER, NH, 03101, US

(73) Assignee: UNION ETCHANTS INTERNATIONAL INC., Woburn, MA (US)

(21) Appl. No.: 11/673,568

(22) Filed: Feb. 10, 2007

Related U.S. Application Data
(60) Provisional application No. 60/772,157, filed on Feb. 10, 2006.

(51) Int. Cl. C01G 1/00

(52) U.S. Cl. 422/243

(57) ABSTRACT

A kit for the recovery of metal is provided. The kit may be used to recover a metal such as gold or an alloy from an iodide-iodine solution. The kit may be provided with substrates containing metal capable of being etched and etchant, a precipitant, cleaner, tweezers, instructions, etc. The kit may be used to illustrate the process of etching or may be used as an analytical tool in classrooms or industry.

### CROSS REFERENCE TO RELATED APPLICATIONS

The present application claims the benefit of the filing date of U.S. Provisional Application Ser. No. 60/772,157, filed Feb. 10, 2006, the teachings of which are incorporated herein by reference.

### FIELD OF INVENTION

The present invention relates generally to the recovery of metal, and more particularly to a kit for the recovery of metal.

### BACKGROUND

Etching solutions have been employed to recover metals from ore and scrap materials and have since been employed in the electronic and jewelry making industries in the etching and stripping of metals. Generally, metal may be removed from a substrate using a solution that may dissolve the metal. The metal may then be precipitated from the solution and recovered.

### SUMMARY

In an exemplary aspect, the present invention relates to a kit for the recovery of metal comprising iodide-iodine; an acid; and a buffer.

In another exemplary aspect, the present invention also relates to a method of providing a kit for the recovery of metal comprising providing iodide-iodine in a container; providing an acid in the container; and providing a buffer in the container.

### BRIEF DESCRIPTION OF THE DRAWINGS

The detailed description below may be better understood with reference to the accompanying figures which are provided for illustrative purposes and are not to be considered as limiting any aspect of the invention.

FIG. 1 is an exemplary embodiment of the present invention.

FIG. 2 is a flow diagram of the metal recovery process.

FIG. 3 is a flow diagram of the metal recovery process to recover a metal from a iodide-iodine solution using acid and a buffer in combination with a dye to precipitate the metal which is then decanted and compared to a known standard.

### DETAILED DESCRIPTION OF THE PREFERRED EMBODIMENTS

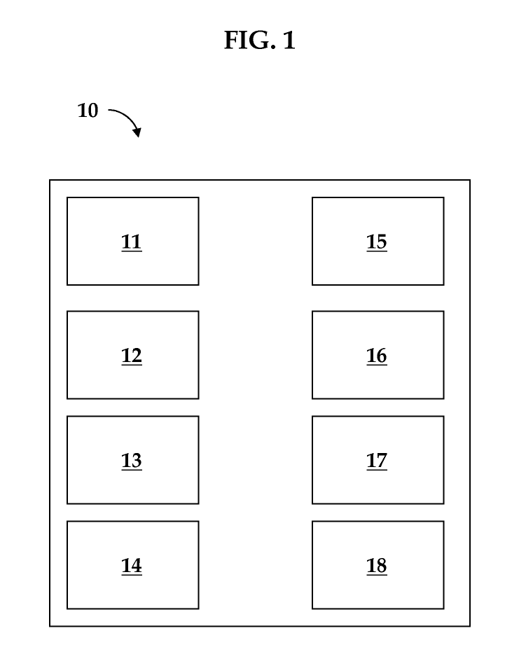

The present invention relates to a kit for the reclamation of metal. The metal may include metals such as gold, other metals and/or alloys suitable for etching. As illustrated in FIG. 1, the kit 10 may include a container of etchant 11, a container of acid 12 and a container of buffer 13. It should be appreciated that the acid and buffer may be supplied together in a container. Optionally a dye 14 may also be provided in the kit, which may also be included in the acid and/or buffer or may be provided separately.

The kit 10 may also include substrates including metal or metal coupons 15. Various metal/substrate combinations may be provided. The substrates may also be provided with various amounts of metal on the substrates, wherein the amount of metal on each substrate may be known or unknown.

Additionally, the kit may include a cleaner 16, suitable for the removal of dirt or oils from the substrates. Tweezers 17 may also be provided in the kit to hold the substrates during the etching process and to agitate the etching solution. Furthermore, instructions 18 as to how the kit may be utilized as a teaching tool or as an analytical tool may be provided.

Etchant may be provided to remove metal from a given substrate. The substrate may be provided with the kit or may be any substrate containing a metal capable of being etched. The etchant may include an iodide-iodine solution, such as for example, a potassium iodide-iodine. In an exemplary embodiment, the etchant may be available from Union Etchants, Woburn Mass., under the trade name AU1 Gold Etchant. The etchant may be provided in either powder or liquid form. When provided in a powder form, liquid, such as water or distilled water, may be added to the powder to form a solution.

The etchant may also be provided and/or packaged in an amount sufficient to provide a stoichiometric test, wherein enough etchant is provided to remove a desired or specific amount of metal from a substrate. For example, sufficient etchant may be provided to remove a half of a gram of gold, or a gram of a metal, or many grams of an alloy, etc. Accordingly, the etchant may be provided in a pre-measured amount depending on the amount and/or type of metal to be removed. The kit may contain both a pre-measured amount of etchant for stoichiometric testing and a given quantity of etchant for general use, illustration or testing.

Acid and a buffer may be provided to precipitate the metal from the etchant solution. In an exemplary embodiment, the acid and buffer may be available from Union Etchants, Woburn Mass., under the trade name GOLDOUT™. The acid and/or buffer may be provided together or separately and in either powder or liquid form. The acid/buffer combination may have a pH within the range of about 6.0 to 9.0, including all ranges and increments therebetween. The acid may include, for example, ascorbic acid. The buffer may include, for example, sodium bicarbonate or a similar material. A dye may also be added to the acid and/or buffer or may be provided separately.

The cleaner may be used to remove dirt and/or oils from the substrates. The cleaner may be provided as a powder or in solution. When provided in powder form, water or distilled water, may be added to the cleaner to form a cleaning solution.

The kit may be used to provide sufficient materials necessary for the etching and recovery of a metal, packaged together in a container and conveniently available. The kit may also be used to illustrate a process for metal recovery and may be used as a teaching tool in, for example, classrooms and industry. The kit may also be used as an analytical tool, such as to compare the recovery rates of different etch and or reclamation products. Accordingly, the kit may be provided with appropriate instructions for use, teaching illustration and/or testing.

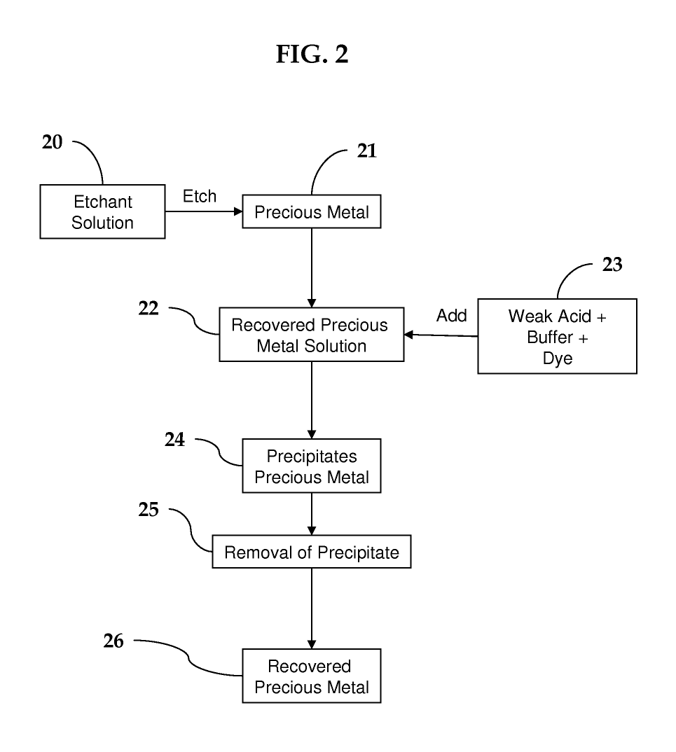

Turning to FIG. 2, illustrative of a method in which the kit may be used, an etchant solution 20 may be used to etch a metal 21 from a substrate. The substrate may be provided with the kit or may be one otherwise provided. The substrate may be placed into the solution utilizing the pair of tweezers provided with the kit. When necessary, the substrate may also be cleaned using the cleaning product provided in the kit prior to etching. The etchant solution containing the metal may be recovered 22. To the recovered etchant solution 23 acid, a buffer and optionally a dye may be added. This may cause the precipitation of metal 24. The precipitate may be removed 25 and the metal 26 may be recovered.

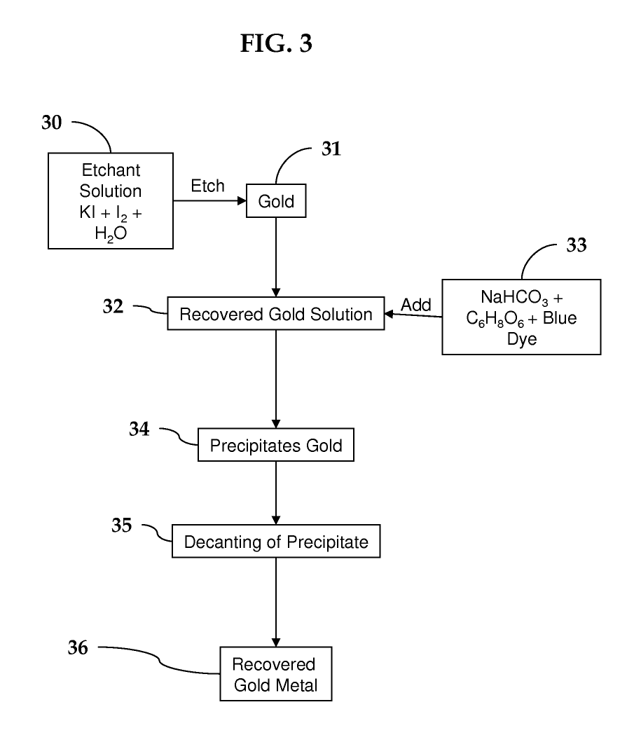

In another exemplary embodiment of a method in which the kit may be used, illustrated in FIG. 3, a iodide-iodine solution 30 may be used to etch metal 31 from a substrate. The substrate may include a known amount of metal or a pre-measured amount of etchant may be used to perform a stoichiometric test, wherein a desired amount of metal may be removed from a substrate. To the recovered etchant solution 32 containing the metal acid, buffer and optionally a dye 33 may be added. This may cause the metal to precipitate 34. The precipitate may be removed by the decanting process 35 and the metal 36 may be recovered. The amount of metal recovered from the etchant solution may be determined and compared to the amount of metal provided on the substrate etched or compared to the amount of metal which should have been removed in the stoichiometric testing.

The kit and the various aspects of the kit, i.e. the etchant, acidibuffer, etc. may be provided in a container. The container may be a single-use container, which may be opened once, or may be a reusable container which may be opened and closed. In addition the container may include slots for the various aspects of the kit.

The foregoing description is provided to illustrate and explain the present invention. However, the description hereinabove should not be considered to limit the scope of the invention set forth in the claims appended here to.

What is claimed is:

1. A kit for the recovery of metal comprising:
iodide-iodine;
an acid; and
a buffer.

2. The kit of claim 1 wherein said iodide-iodine comprises potassium iodide-iodine.

3. The kit of claim 1 further comprising cleaner.

4. The kit of claim 1 further comprising a dye.

5. The kit of claim 1 wherein said acid comprises ascorbic acid.

6. The kit of claim 1 wherein said acid and buffer have a combined pH in the range of about 6.0-9.0.

7. The kit of claim 1 wherein said buffer comprises sodium bicarbonate.

8. The kit of claim 1 further comprising a substrate including a metal.

9. The kit of claim 8 wherein said metal is plated on said substrate.

10. The kit of claim 8 wherein said metal is present in a known amount.

11. The kit of claim 8 wherein said metal is gold.

12. The kit of claim 1 further comprising instructions.

13. The kit of claim 1 further comprising a pair of tweezers.

14. The kit of claim 1 wherein said iodide-iodine is provided in a pre-measured amount.

15. A method of providing a kit for the recovery of metal comprising:
providing iodide-iodine in a container;
providing an acid in said container; and
providing a buffer in said container.

16. The method of claim 15 further comprising providing cleaner in said container.

17. The method of claim 15 further comprising providing tweezers in said container.

18. The method of claim 15 further comprising providing a metal on a substrate in said container.

19. The method of claim 18 wherein said metal is provided on said substrate in a known amount.

20. The method of claim 15 wherein said iodide-iodine is provided in a pre-measured amount to remove a known amount of metal.
